(19) United States
(12) Patent Application Publication
(10) Pub. No.: US 2021/0224750 A1
(43) Pub. Date: Jul. 22, 2021

(54) QUALITY-BASED SCORING

(71) Applicant: Microsoft Technology Licensing, LLC, Redmond, WA (US)

(72) Inventors: Xiaonan Duan, Sunnyvale, CA (US); Fenglin Li, Santa Clara, CA (US)

(73) Assignee: Microsoft Technology Licensing, LLC, Redmond, WA (US)

(21) Appl. No.: 16/745,623

(22) Filed: Jan. 17, 2020

(51) Int. Cl. G06Q 10/10; G06Q 10/06; G06K 9/62; G06N 20/20; G06F 16/9535

(52) U.S. Cl. CPC G06Q 10/1053; G06Q 10/063112; G06F 16/9535; G06K 9/6263; G06N 20/20; G06K 9/6257

(57) ABSTRACT

The disclosed embodiments provide a system for performing quality-based scoring. During operation, the system determines, based on data retrieved from a data store in an online system, features related to a completeness of attributes in an opportunity posted in the online system and a source of the opportunity. Next, the system performs one or more operations that apply a first machine learning model to the features to generate a quality score representing a prediction of user engagement with the opportunity. The system then adjusts calculation of a relevance score representing a likelihood of a positive outcome between a user and the opportunity based on the quality score. Finally, the system modifies content outputted in a user interface of the online system based on the adjusted calculation of the relevance score.

### BACKGROUND

### Field

The disclosed embodiments relate to managing content and user interfaces in online systems. More specifically, the disclosed embodiments relate to techniques for performing quality-based scoring related to the management of content and user interfaces.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be implemented and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for performing quality-based scoring in accordance with the disclosed embodiments.

FIG. 3 shows a flowchart illustrating a process of performing quality-based scoring in accordance with the disclosed embodiments.

FIG. 4 shows a flowchart illustrating a process of training a machine learning model to predict quality in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing content and/or user interfaces in online systems. For example, the content includes jobs and/or other opportunities that are posted within an online system such as an online network and/or online marketplace. The user interfaces include graphical user interfaces (GUIs), web-based user interfaces, and/or other types of interfaces that allow members of the online system to access the content and/or features in the online system from computer systems, mobile devices, gaming consoles, televisions, home assistants, and/or other network-enabled electronic devices.

More specifically, the disclosed embodiments provide a method, apparatus, and system for assessing the quality of jobs (or other opportunities or types of content) posted in an online system and using the assessed quality to improve the output of the jobs in a user interface of the online system. In these embodiments, the quality of a job is assessed based on factors such as user engagement with the job, user reviews of the job, and/or the accessibility of the job to users. A higher quality job is associated with higher user engagement, user perception, and/or accessibility, and a lower quality job is associated with lower user engagement, user perception, and/or accessibility.

In some embodiments, job quality is assessed using a numeric score that is calculated based on features related to jobs posted in an online system. For example, the features include indicators of the completeness of attributes in a job, the source of the job, and/or the accessibility of the job or an application for the job (e.g., the number of clicks or redirects required to apply to the job). The features are inputted into a first machine learning model, and the first machine learning model outputs a quality score representing a predicted level of user engagement with the job.

Continuing with the above example, the predicted level of user engagement includes, but is not limited to, an impression volume (e.g., total number of impressions, number of impressions over a period, etc.), a click-through rate (CTR), a rate of applications to a job, given impressions of the job (e.g., the number of applications divided by the number of impressions); and/or a rate of response to applications for a job (e.g., the number of responses to applications divided by the number of applications). In other words, the level of user engagement represents a total number of “positive” interactions between users and the job (e.g., interactions that improve the likelihood of placing the job) and/or a rate of positive interactions between users and the job. In turn, the predicted level of user engagement acts as a proxy for user perceptions of the job's quality, with a higher-quality job indicating a higher likelihood of being legitimate, having an experienced or professional job poster, or otherwise resulting in a better job application experience.

The job quality score is subsequently used to generate and/or modify output of the job to users of the online system. For example, the quality score is inputted with additional features between the job and a user into a second machine learning model, and the second machine learning model outputs a separate relevance score representing the compatibility of the user with the job and/or the likelihood of a positive outcome between the user and job (e.g., the likelihood that the user clicks on, applies to, or has another type of positive interaction with the job). Unlike the quality score predicted by the first machine learning model, the second machine learning model accounts for similarity or overlap in attributes of the job and user in calculating the relevance score. The relevance score is then used to select or omit outputting of the job to the user within a user interface of the online system.

In another example, the quality score is compared to a threshold, and the job is omitted from output to the user if the quality score falls below the threshold. Because the job quality score can be used to filter jobs or other content from calculation of relevance scores or other subsequent processing, the disclosed embodiments improve latency, resource usage, and/or computational overhead associated with selecting and outputting the content in a user interface.

The job quality score is also, or instead, used to generate recommendations and/or output for tracking or improving the quality of the job. For example, the job's quality score is outputted to a poster of the job, along with one or more factors that contribute to a lower value of the quality score. The poster is thus able to make improvements that increase the job's quality, thereby attracting more and/or better applicants to the job. In another example, the job's quality score is aggregated with quality scores for other jobs (e.g., similar jobs, jobs in the same industry, etc.) to track overall quality in various groupings of jobs over time and/or correlate the overall quality with outcomes associated with the groupings of jobs.

By assessing the quality of jobs (or other types of opportunities) based on features that affect user perception of or engagement with the jobs, the disclosed embodiments allow higher quality jobs to be prioritized over lower quality jobs in recommendations, search results, and/or user interface output containing the jobs to users. In turn, the users perceive the recommendations to be more legitimate or higher quality, which encourages the users to interact with the jobs and improves application rates, hiring rates, and/or other positive outcomes associated with the jobs. The increased efficiency and/or effectiveness of the users' interaction with jobs additionally reduces processing of job searches, job applications, and/or other job-related activity, thereby improving the utilization of processor, memory, storage, input/output (I/O), and/or other resources involved in such processing. Omitting the calculation of relevance scores for jobs with low quality scores further reduces resource consumption, latency, and/or overhead associated with generating job recommendations and/or search results based on rankings of the relevance scores.

In contrast, conventional techniques select and output content to users without considering user engagement, completeness, and/or other indicators of user-perceived quality of the content. As a result, content that is selected for output to the users can vary in user-perceived quality, which can adversely impact the usability or effectiveness of user interfaces, online systems, or devices that deliver the content to the users. Because the conventional techniques do not filter the content by quality, additional latency, resource consumption, and/or overhead are incurred in generating relevance scores for a larger set of content before a subset of the content is selected for delivery or output to the users. Consequently, the disclosed embodiments improve computer systems, applications, user experiences, tools, and/or technologies related to generating recommendations, delivering online content, employment, recruiting, and/or hiring.

### Quality-Based Scoring and Recommendations

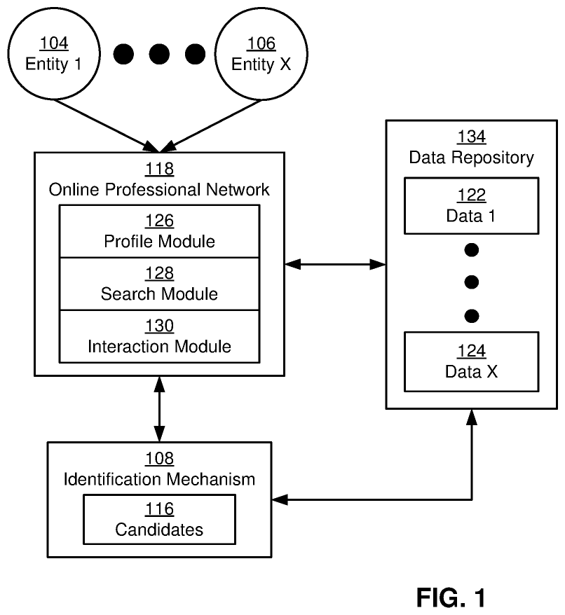

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is logged and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may log searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 identifies candidates 116 as users who have viewed, searched for, and/or applied to jobs, positions, roles, and/or opportunities, within or outside online network 118. Identification mechanism 108 also, or instead, identifies candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 are inputted into the machine learning model(s), along with features and/or characteristics of the corresponding opportunities (e.g., required or desired skills, education, experience, industry, title, etc.). The machine learning model(s) then output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) further adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings may also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

On the other hand, rankings and/or recommendations of opportunities to candidates 116 may fail to account for the quality of the opportunities. For example, machine learning models used to match candidates 116 with jobs (or other opportunities or content) may calculate scores between candidates 116 and the jobs based on the relevance of the jobs to candidates 116. Such relevance is determined based on comparisons of attributes of the jobs with corresponding attributes of candidates 116. As a result, jobs may be recommended to candidates 116 even when the jobs lack important attributes or descriptions; are hard to access or apply to; have spelling, grammar, and/or punctuation mistakes; and/or are otherwise perceived as low-quality or fake.

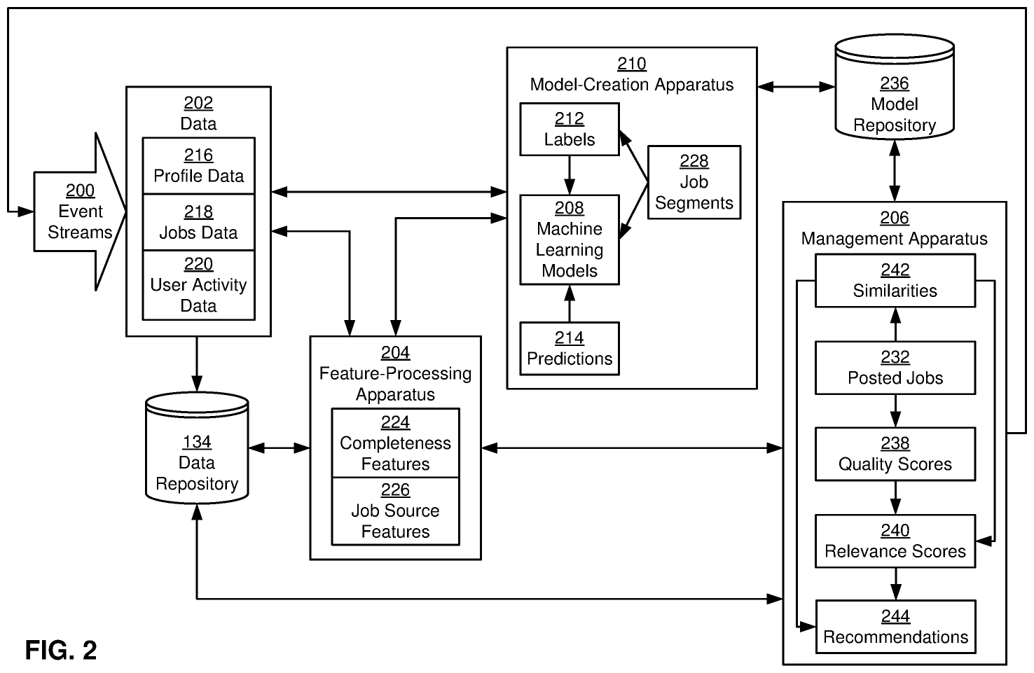

In one or more embodiments, job searches, job applications, and/or other types of interactions involving members of online network 118 are improved by assessing the quality of jobs in online network 118 and generating recommendations and/or other output based on the assessed quality. As shown in FIG. 2, data repository 134 and/or another primary data store are queried for data 202 that includes profile data 216 for members of an online system (e.g., online network 118 of FIG. 1), jobs data 218 for jobs that are listed or described within or outside the online system, and/or user activity data 220 that logs the members' activity within and/or outside the online system.

Profile data 216 includes data associated with member profiles in the platform. For example, profile data 216 for an online professional network includes a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 also includes a set of groups to which the user belongs, the user's contacts and/or connections, awards or honors earned by the user, licenses or certifications attained by the user, patents or publications associated with the user, and/or other data related to the user's interaction with the platform.

Attributes of the members are optionally matched to a number of member segments, with each member segment containing a group of members that share one or more common attributes. For example, member segments in the platform may be defined to include members with the same industry, title, location, and/or language.

Connection information in profile data 216 is optionally combined into a graph, with nodes in the graph representing entities (e.g., users, schools, companies, locations, etc.) in the platform. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted or provided by members of the online system. For example, jobs data 218 for a given job or job listing include a declared or inferred title, company, required or desired skills, responsibilities, qualifications, role, location, industry, seniority, salary range, benefits, and/or member segment.

User activity data 220 includes records of user interactions with one another and/or content associated with the platform. For example, user activity data 220 logs impressions, clicks, likes, dislikes, shares, hides, comments, posts, updates, conversions, and/or other user interaction with content in the platform. User activity data 220 also, or instead, logs other types of activity, including connections, messages, job applications, job searches, recruiter searches for candidates, interaction between candidates 116 and recruiters, and/or interaction with groups or events. In some embodiments, user activity data 220 further includes social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 220 additionally includes schedules, calendars, and/or upcoming availabilities of the users, which may be used to schedule meetings, interviews, and/or events for the users. Like profile data 216, user activity data 220 is optionally used to create a graph, with nodes in the graph representing members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

In one or more embodiments, profile data 216, jobs data 218, user activity data 220, and/or other data 202 in data repository 134 is standardized before the data is used by components of the system. For example, skills in profile data 216 and/or jobs data 218 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online system. In a fifth example, data repository 134 includes standardized time periods (e.g., daily, weekly, monthly, quarterly, yearly, etc.) that can be used to retrieve profile data 216, jobs data 218, user activity data 220, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform. One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A feature-processing apparatus 204 uses data 202 from event streams 200 and/or data repository 134 to calculate a set of features for a job (or other opportunity). For example, feature-processing apparatus 204 executes on an offline, periodic, and/or batch-processing basis to produce features for a large number of jobs. In another example, feature-processing apparatus 204 generates features in an online, nearline, and/or on-demand basis based on recent activity related to posting of the job and/or after a job has been posted for a pre-specified period (e.g., a number of days, weeks, or months).

In one or more embodiments, feature-processing apparatus 204 generates completeness features 224 and job source features 226 for the job. Completeness features 224 characterize the completeness of various attributes in jobs data 218 for the job. For example, completeness features 224 include binary indicators of the presence or absence of standardized versions of a title, skills, function, seniority, company, industry, region, and/or other attributes in the job. In another example, completeness features 224 include binary indicators of the presence or absence of non-standardized attributes such as salary, commute time, benefits, career paths, and/or a company picture. In a third example, completeness features 224 include metrics that characterize the overall completeness of the job. Such metrics include, but are not limited to, the total number of attributes, words, sentences, and/or other units of content in the job.

Job source features 226 relate to the source of the job and/or applications for the job. For example, job source features 226 identify the source of the job as a moderator of the job (e.g., a recruiter, hiring manager, and/or another entity responsible for placing the job) or a third-party source (e.g., a job board, applicant tracking system (ATS), company career page, job aggregator, etc.). In another example, job source features 226 include the number of Uniform Resource Locator (URL) redirects or clicks required to access an application for the job from the posting of the job in the online system. In this example, a job with an onsite application in the online system has zero redirects, while a job with an offsite application on a third-party system has one or more redirects.

After completeness features 224 and job source features 226 are generated for one or more jobs, feature-processing apparatus 204 stores the features in data repository 134 for subsequent retrieval and use. Feature-processing apparatus 204 may also, or instead, provide the features to a model-creation apparatus 210, a management apparatus 206, and/or another component of the system for use in creating and/or executing machine learning models 208 using the features.

Model-creation apparatus 210 trains and/or updates one or more machine learning models 208 using sets of features from feature-processing apparatus 204, labels 212 representing outcomes associated with the feature sets, and predictions 214 produced from the feature sets. In general, model-creation apparatus 210 may produce machine learning models 208 that generate predictions 214 and/or estimates of labels 212 that characterize levels of user engagement with jobs, with the levels of user engagement acting as indicators of user perception of the jobs' quality. These levels of user engagement include, but are not limited to, a total number of “positive” interactions between users and the job (e.g., interactions that improve the likelihood of placing the job) and/or a rate of positive interactions between users and the job.

For example, labels 212 include, but are not limited to, an impression volume (e.g., total number of impressions, number of impressions over a period, etc.), a click-through rate (CTR), a rate of applications to a job, given impressions of the job (e.g., the number of applications divided by the number of impressions); and/or a rate of response to applications for a job (e.g., the number of responses to applications divided by the number of applications). Output of machine learning models 208 includes a separate prediction per label (e.g., a vector of multiple values, with each value representing a different measure of user engagement). Alternatively, the output includes an overall score that represents a weighted combination of predictions of different measures of user engagement with a corresponding job.

More specifically, model-creation apparatus 210 uses labels 212 and corresponding completeness features 224 and job source features 226 for the jobs to update parameters of machine learning models 208. For example, model-creation apparatus 210 inputs completeness features 224, job source features 226, and labels 212 as training data for one or more regression models, random forests, deep learning models, and/or other types of machine learning models 208. Model-creation apparatus 210 then uses a training technique and/or one or more hyperparameters to update parameter values of machine learning models 208 so that predictions 214 outputted by machine learning models 208 from different sets of features reflect the corresponding labels 212.

In one or more embodiments, model-creation apparatus 210 and/or another component determine values of labels 212 and/or train machine learning models 208 in a way that controls for external factors that affect the values of labels 212. In some embodiments, combinations of the factors are represented as different job segments 228 of jobs posted or delivered in the online system. Job segments 228 represent different sources, hosting locations, and/or other characteristics related to posting or delivery of the jobs. For example, job segments 228 include a first job segment representing paid jobs that receive applications at an offsite source that is external to the online system (e.g., a “careers” page on a company's external website). Job segments 228 may also include a second job segment representing paid jobs that receive applications at an onsite source within the online system (e.g., a jobs module or feature). Job segments 228 may further include a third job segment representing free (unpaid) jobs that are imported into the online system through distribution partnerships, application-programming interfaces (APIs), scraping, data feeds, and/or other data sources. In another example, job segments 228 may be associated with different job recencies (e.g., the number of days since a job was posted) and/or values of standardized attributes in jobs (e.g., title, skills, industry, function, company size, location, etc.).

To control for confounding factors represented by job segments 228, the component calculates labels 212 based on user activity 220 associated with jobs in different job segments 228. For example, the component determines impression volumes, CTRs, application rates, response rates, and/or other measures of user engagement for a job at different points after the job has been posted (e.g., one week after posting, two weeks after posting, etc.). Such measures can be calculated by aggregating different types of user activity 220 over various time periods (e.g., daily, weekly, the first week after a job is posted, the second week after the job is posted, etc.). The calculated labels 212 can then be stored with the corresponding features in data repository 134 and/or another data store. Labels 212 and the corresponding features can also, or instead, be stored in separate data stores and linked to one another via keys and/or other types of relationships.

Model-creation apparatus 210 then trains machine learning models 208 in a way that accounts for job segments 238 and/or the confounding factors. For example, model-creation apparatus 210 includes values of factors representing job segments 228 as features inputted into machine learning models 208 to allow machine learning models 208 to learn the effects of the factors on values of labels 212. In another example, model-creation apparatus 210 produces different machine learning models 208 for different job segments 228 of jobs, so that each machine learning model learns to produce labels 212 for a given type of job posting, job recency, and/or combination of standardized job attributes.

In some embodiments, model-creation apparatus 210 and/or another component select individual completeness features 224, job source features 226, and/or other features as input into machine learning models 208 based on causal analysis that analyzes the features for potentially causal relationships with labels 212. For example, the component uses a coarsened exact matching (CEM) technique to estimate causal effects of individual features on labels 212 while controlling for confounding factors represented by job segments 228. The component then selects features with higher impact on labels 212 as input into machine learning models 208. As with the generation of machine learning models 208 and/or labels 212, different sets of features may be selected as input into machine learning models 208 for different job segments 228.

After machine learning models 208 are trained and/or updated, model-creation apparatus 210 stores parameters of machine learning models 208 in a model repository 236. For example, model-creation apparatus 210 replaces old values of the parameters in model repository 236 with the updated parameters, or model-creation apparatus 210 stores the updated parameters separately from the old values (e.g., by storing each set of parameters with a different version number of the corresponding machine learning model).

A management apparatus 206 uses the latest versions of machine learning models 208 to generate quality scores 238 and/or recommendations 244 for additional posted jobs 232. In particular, management apparatus 206 retrieves, from model-creation apparatus 210 and/or model repository 236, the latest parameters of one or more machine learning models 208 that have been generated for job segments 238. Management apparatus 206 also retrieves completeness features 224 and interaction features 226 for currently posted jobs 232 in the online system that are not included in training data for machine learning models 208 from feature-processing apparatus 204 and/or data repository 134.

For each job in posted jobs 232, management apparatus 206 selects, from machine learning models 208, a machine learning model associated with a job segment of the job. Next, management apparatus 206 applies the selected machine learning model to the corresponding features to generate a quality score (e.g., quality scores 238) representing the predicted level of user engagement with the job. As with the generation of features inputted into machine learning models 208, quality scores 238 may be produced in an offline, batch-processing, and/or periodic basis (e.g., from batches of features), or quality scores 238 may be generated in an online, nearline, and/or on-demand basis (e.g., when a job is posted, when a candidate performs a job search and/or accesses a jobs-related feature or module in the online system, etc.).

Management apparatus 206 then generates relevance scores 240 between users and posted jobs 232 and/or recommendations 244 related to the users and jobs based on quality scores 238. For example, management apparatus 206 inputs a quality score for a job with additional features related to the job and a user into a second machine learning model, and the second machine learning model outputs a separate relevance score (e.g., relevance scores 240) representing the likelihood of a positive outcome between the user and job. The positive outcome includes, but is not limited to, the user clicking on the job, saving the job, applying to the job, receiving a response to the job application, receiving an offer for the job, and/or accepting the offer. In general, the positive outcome includes an interaction or result involving the user that increases the likelihood of successfully hiring for the job.

Management apparatus 206 then ranks, for a given user, a set of posted jobs 232 (e.g., jobs that match a job search by the user, jobs identified as relevant to the user's profile or career interests, etc.) by descending relevance score. Finally, management apparatus 206 outputs some or all of the ranked jobs as recommendations 224 to the user (e.g., within a job search tool, email, notification, message, and/or another communication or module). Subsequent responses to recommendations 244 may, in turn, be used to generate events that are fed back into the system and used to update features, machine learning models 208, quality scores 238, relevance scores 240, and/or recommendations 244.

Management apparatus 206 also, or instead, filters posted jobs 232 by quality scores 238 before generating relevance scores 240 and/or recommendations 244 related to posted jobs 232. For example, management apparatus 206 compares each quality score with a threshold. If the quality score falls below the threshold, management apparatus 206 omits the calculation of relevance scores 240 and/or generation of recommendations 244 from the corresponding job so that only posted jobs 232 that meet a minimum standard for quality are included in recommendations 244. Because fewer relevance scores 240 are calculated, the resource overhead and/or latency associated with processing requests for recommendations 244 is reduced. Moreover, such filtering can be enabled or disabled (e.g., as a setting for job searches by the users) or automatically applied to some or all types of recommendations 244 (e.g., to prevent low-quality jobs from being recommended to users).

To further improve processing and/or user impressions of recommendations 244, management apparatus 206 includes functionality to generate relevance scores 240 and/or recommendations 244 in a way that accounts for similarities 242 in posted jobs 232. More specifically, management apparatus 206 uses similarities 242 to perform deduplication of posted jobs 232 before relevance scores 240 and/or recommendations 244 related to posted jobs 232 are generated. First, management apparatus 206 identifies pairs of posted jobs 232 that share a common location, company, title, and/or other standardized attribute. In some embodiments, this common set of standardized attributes is used to identify posted jobs 232 with a general similarity with one another.

Next, management apparatus 206 calculates embeddings of job descriptions and/or other text in each pair of jobs. For example, management apparatus 206 generates each embedding by applying a word2vec, Global Vectors for Word Representation (GloVe), FastText, Embeddings from language models (ELMo), and/or another type of embedding model to a bag-of-words and/or one-hot encoded representation of text in a corresponding job. The embedding model(s) include one or more neural networks that learn the semantic context of words, n-grams, and/or phrases in the text. In turn, embeddings of the words, n-grams, and/or phrases in a given job can be obtained as fixed-length vectors from the weight matrix of one or more hidden layers in the trained embedding model(s).

Management apparatus 206 then calculates a similarity (e.g., similarities 242) between each pair of jobs as a cosine similarity, Euclidean distance, and/or another measure of vector similarity between the corresponding embeddings. When the similarity exceeds a threshold, management apparatus 206 omits the generation of relevance scores 240 and/or recommendations 244 for the job that is older, has a lower quality score, and/or is otherwise less likely to result in user engagement. In turn, users are more likely to see a diverse set of jobs in recommendations 244 instead of multiple jobs that appear to be the same or highly similar. At the same time, the omission of jobs with similarities 242 that exceed a threshold from calculation of relevance scores 240 and/or the generation of recommendations 244 reduces resource consumption and/or latency associated with recommending jobs to users.

In some embodiments, recommendations 244 are additionally outputted to moderators of posted jobs 232 based on the corresponding quality scores 238. For example, management apparatus 206 outputs, to a moderator of a job (e.g., the job's poster, hiring manager, recruiter, etc.), the job's quality score, along with values of features that have the greatest affect on a lower value of the quality score (e.g., missing attributes, a third-party or “less trusted” source of the job, etc.). As a result, the moderator can update the job to correct the deficiency and increase the job's quality, thereby attracting more and/or better applicants to the job.

In another example, quality scores 238 for multiple posted jobs 232 (e.g., similar jobs, jobs in the same job segment, jobs from the same company or recruiting agency, etc.) are aggregated (e.g., averaged) to track overall quality in various groupings of jobs over time and/or correlate the overall quality with outcomes for the groupings of jobs. The tracked and/or correlated quality can then be used to develop strategies and/or features in the online system that encourage the posting of higher quality jobs from various job segments 228. Continuing with this example, a first set of jobs with high quality scores 238 or levels of user engagement is compared with a second set of jobs with lower quality scores 238 or levels of user engagement to identify differences in the first and second sets of jobs. The identified differences can then be used to develop tips, user-interface tools, or other mechanisms that encourage job posters to submit higher-quality jobs to the online system.

By assessing the quality of posted jobs 232 (or other types of opportunities) based on features that affect user perception of or engagement with the jobs, the system of FIG. 2 allows higher quality jobs to be prioritized over lower quality jobs in recommendations 244 to users. In turn, the users perceive recommendations 244 to be more legitimate or higher quality, which encourages the users to interact with posted jobs 232 and improves application rates, hiring rates, and/or other positive outcomes associated with posted jobs 232. The increased efficiency and/or effectiveness of the users' interaction with posted jobs 232 additionally reduces processing of job searches, job applications, and/or other job-related activity, thereby improving the utilization of processor, memory, storage, input/output (I/O), and/or other resources involved in such processing. Omitting the calculation of relevance scores 240 for jobs with low quality scores 238 and/or jobs that are highly similar to other jobs further reduces resource consumption, latency, and/or overhead associated with generating recommendations 244 and/or search results based on rankings of relevance scores 240. Consequently, the disclosed embodiments improve computer systems, applications, user experiences, tools, and/or technologies related to generating recommendations, delivering online content, employment, recruiting, and/or hiring.

Those skilled in the art will appreciate that the system of FIG. 2 may be implemented in a variety of ways. First, feature-processing apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Feature-processing apparatus 204, model-creation apparatus 210, and management apparatus 206 may additionally be implemented together and/or separately by one or more hardware and/or software components and/or layers.

Second, a number of machine learning models 208 and/or techniques may be used to generate predictions 214, quality scores 238, relevance scores 240, similarities 242, and/or recommendations 244. For example, the functionality of each machine learning model may be provided by a regression model, artificial neural network, support vector machine, decision tree, gradient boosted tree, random forest, naïve Bayes classifier, Bayesian network, clustering technique, collaborative filtering technique, deep learning model, hierarchical model, ensemble model, embedding model, and/or another type of machine learning technique. The retraining or execution of each machine learning model may also be performed on an offline, online, and/or on-demand basis to accommodate requirements or limitations associated with the processing, performance, or scalability of the system and/or the availability of features and labels 212 used to train the machine learning model. Multiple versions of a machine learning model may further be adapted to different subsets of jobs (e.g., free jobs, paid jobs, jobs with onsite sources, jobs with offsite sources, jobs from different industries, jobs for different company sizes, jobs with different recencies, etc.). Conversely, the same machine learning model may be used to generate quality scores 238 and/or relevance scores 240 for all jobs.

Third, the system of FIG. 2 may be adapted to different types of content. For example, the system may be used to infer user perceptions of and/or user engagement with advertisements, posts, articles, marketing content, online dating profiles, reviews, and/or listings of goods or services.

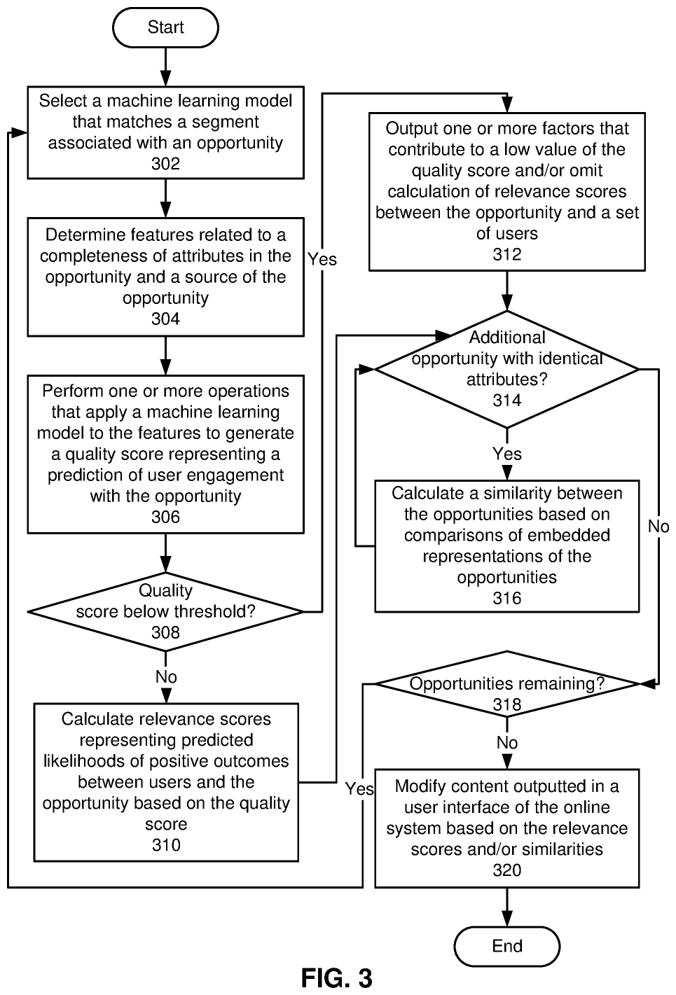

FIG. 3 shows a flowchart illustrating a process of performing quality-based scoring and recommendations in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a machine learning model that matches a segment associated with an opportunity is selected (operation 302). For example, the machine learning model is trained on opportunities in a job segment that represents a recency of the jobs, a type of job posting in an online system, and/or a value of one or more attributes in the jobs (e.g., industry, region, function, title, etc.). Operation 302 is omitted if attributes that define the job segment are included as input into the machine learning model.

Next, features related to a completeness of attributes in the opportunity and a source of the opportunity are determined (operation 304). For example, features related to the completeness of attributes include indicators of the presence or absence of a title, skill, function, seniority, industry, region, company, and/or company picture in the posted opportunity in the online system. The features also, or instead, include an overall measure of completeness of the opportunity and/or individual portions of the opportunity. In another example, features related to the source of the opportunity identify the source as a moderator of the opportunity (e.g., a recruiter, hiring manager, and/or another entity involved in placing the opportunity) or a third-party source (e.g., a job board, ATS, job aggregator, career page, etc.). The features also, or instead, include the number of clicks or redirects from the posted opportunity to an application for the opportunity.

One or more operations are performed that apply a machine learning model to the features to generate a quality score representing a prediction of user engagement with the opportunity (operation 306). For example, the features are inputted into the machine learning model, and the machine learning model outputs one or more scores representing predictions related to different types of engagement with the opportunity (e.g., impression volume, CTR, a rate of applications to the opportunity after impressions of the opportunity, a rate of response to the applications, etc.) from users that are exposed to the opportunity.

Subsequent processing related to the opportunity is determined based on comparison of the quality score to a threshold (operation 308). For example, the threshold represents a minimum quality score to be achieved by opportunities posted in the online system. When the opportunity's quality score meets or exceeds the threshold, relevance scores representing predicted likelihoods of positive outcomes between users and the opportunity are calculated based on the quality score (operation 310). For example, a second machine learning model is applied to the quality score and additional features related to the opportunity and the users to produce the relevance scores. As a result, the quality score can be used by the second machine learning model as a factor that influences the relevance score between the opportunity and each user (e.g., a low quality score reduces one or more relevance scores for the opportunity, a high quality score increases the relevance score(s), etc.).

When the opportunity's quality score does not meet the threshold, one or more factors that contribute to a low value of the quality score are outputted and/or calculation of relevance scores between the opportunity and a set of users is omitted (operation 312). For example, the low quality score is outputted to a moderator of the opportunity, along with values of features that have the greatest contribution to the low quality score. The moderator is thus able to revise the content in the opportunity in a way that increases the quality of the opportunity and subsequent user engagement with and/or outcomes related to the opportunity. In another example, subsequent scoring, ranking, and/or delivery of the opportunity in the online system is omitted if the quality score falls below the threshold to prevent jobs with low predicted user engagement from being shown to users.

Subsequent processing related to the opportunity is determined based on the presence or absence of an additional opportunity with identical attributes (operation 314) to the opportunity. For example, the additional opportunity may be matched to the opportunity when both opportunities include the same title, region, and/or company, which indicates a general similarity between the opportunities.

When a matching opportunity is found, a similarity between the opportunities is calculated based on comparisons of embedded representations of the opportunities (operation 316). For example, the embedded representations are generated from descriptions and/or other portions of the opportunities. The similarity is then calculated as a cosine similarity, Euclidean distance, and/or another measure of vector similarity between the embedded representations. Operation 316 is repeated for additional opportunities (operation 314) with the same attributes as the opportunity. When no opportunities with identical attributes to the opportunity are found, operation 312 is omitted.

Operations 302-316 may be repeated for a number of remaining opportunities (operation 318). For example, one or more machine learning models may be used to generate quality scores for some or all jobs (or other opportunities) posted in the online system (operations 302-306). The quality scores are used to calculate relevance scores for the jobs, omit the calculation of relevance scores, and/or output factors that contribute to low values of the quality scores (operations 308-312). Similarities between or among the opportunities are also determined (operations 314-316).

Finally, content outputted in a user interface of the online system is modified based on the relevance scores and/or any similarities calculated between the opportunity and other opportunities with identical attributes (operation 320). For example, an opportunity is outputted to a user (e.g., in a recommendation, search result, content feed, etc.) if the relevance score between the user and opportunity exceeds a threshold and/or the opportunity is at or near the front of a ranking of opportunities by descending relevance score with the user. Conversely, the opportunity is not outputted to a user if calculation of a relevance score between the opportunity and the user is omitted (e.g., because the opportunity's quality score is too low, the opportunity does not match any of the user's attributes or preferences, etc.). In another example, the similarity between the opportunity and another opportunity is compared to a threshold. When the similarity exceeds the threshold, generation of a relevance score and/or output of a lower quality opportunity selected from the two opportunities (e.g., the opportunity with the lower quality score) is omitted to improve the quality of the outputted content and/or reduce latency, resource consumption, or other overhead associated with processing and outputting the content.

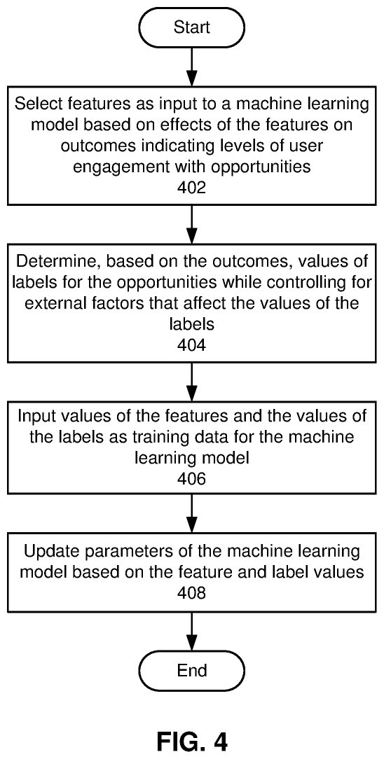

FIG. 4 shows a flowchart illustrating a process of training a machine learning model to predict quality in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, features are selected as input to the machine learning model based on effects of the features on outcomes indicating levels of user engagement with opportunities (operation 402). For example, the outcomes include, but are not limited to, impression volumes for a set of opportunities, CTRs for the opportunities, rates of applications given impressions of the opportunities, and/or rates of response to the applications. As mentioned above, the features characterize the completeness of attributes in the opportunities, sources of the opportunities, and/or external confounding factors that affect the values of the labels. CEM and/or another causal analysis technique is used to assess the impact of each feature on the outcomes, and features with a greater impact on the outcomes are selected as input to the machine learning model.

Next, values of labels for the opportunities are determined based on the outcomes while controlling for the external factors (operation 404). For example, the impression volumes, CTR, application rates, and/or response rates are calculated in a way that controls for the number of days since the opportunities have been posted (e.g., one label is calculated from outcomes for a job one week after the job was posted and another label is calculated from outcomes for the job two weeks after the job was posted), types of postings of the opportunities (e.g., a job that is shown to users via multiple delivery channels in the online system includes multiple labels, one for each channel), and/or values of attributes in the opportunities.

Values of the features and the values of the labels are then inputted as training data for the machine learning model (operation 406), and parameters of the machine learning model are updated based on the feature and label values (operation 408). For example, feature values for each opportunity are inputted into the machine learning model, and the parameters of the machine learning are updated so that the output generated by the machine learning model from the feature values reflects one or more label values corresponding to the inputted feature values. The trained machine learning model is then used to generate quality scores representing predicted levels of user engagement with other opportunities, as discussed above.

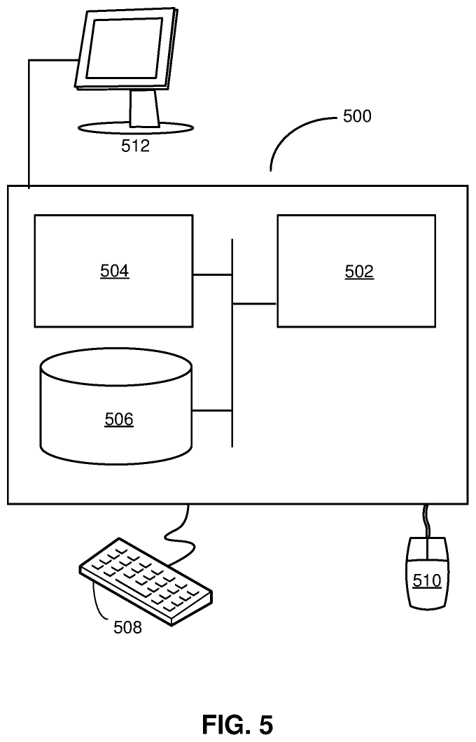

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 also includes input/output (I/O) devices such as a keyboard 508, a mouse 510, and a display 512.

Computer system 500 includes functionality to execute various components of the present embodiments. In particular, computer system 500 includes an operating system (not shown) that coordinates the use of hardware and software resources on computer system 500, as well as one or more applications that perform specialized tasks for the user. To perform tasks for the user, applications obtain the use of hardware resources on computer system 500 from the operating system, as well as interact with the user through a hardware and/or software framework provided by the operating system.

In one or more embodiments, computer system 500 provides a system for performing quality-based scoring and recommendations. The system includes a feature-processing apparatus, a model-creation apparatus, and a management apparatus, one or more of which may alternatively be termed or implemented as a module, mechanism, or other type of system component. The model-creation apparatus selects, as input to a machine learning model, features related to a completeness of attributes in opportunities posted in an online system and sources of the opportunities based on effects of the features on labels representing the level of user engagement with the opportunities. The model-creation apparatus also determines values of the labels for the opportunities while controlling for external factors that affect the values of the labels. The model-creation apparatus further inputs values of the features for the opportunities and the values of the labels as training data for the machine learning model and updates parameters of the machine learning model based on the values of the features and the values of the labels.

The feature-processing apparatus determines, based on data retrieved from a data store in an online system, features for a given opportunity. Next, the management apparatus performs one or more operations that apply the machine learning model to the features to generate a quality score representing a prediction of user engagement with the opportunity. The management apparatus then adjusts calculation of a relevance score representing a likelihood of a positive outcome between the user and the opportunity and/or a compatibility of the user with the opportunity based on the quality score. For example, the management apparatus applies a second machine learning model to the quality score and additional features related to the opportunity and the user to produce the relevance score. Alternatively, when the quality score falls below a threshold, the management apparatus omits calculation of the relevance score between the opportunity and the user. Finally, the management apparatus outputs, in a user interface of the online system, a recommendation related to the user and the opportunity based on the adjusted calculation of the relevance score.

In addition, one or more components of computer system 500 may be remotely located and connected to the other components over a network. Portions of the present embodiments (e.g., feature-processing apparatus, model-creation apparatus, management apparatus, data repository, model repository, online network, etc.) may also be located on different nodes of a distributed system that implements the embodiments. For example, the present embodiments may be implemented using a cloud computing system that generates quality scores and/or recommendations related to a set of remote jobs and/or users.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, based on data retrieved from a data store in an online system, features related to:
a completeness of attributes in an opportunity posted in the online system; and
a source of the opportunity;
performing one or more operations that apply a first machine learning model to the features to generate a quality score representing a prediction of user engagement with the opportunity;
adjusting calculation of a relevance score representing a likelihood of a positive outcome between a user and the opportunity based on the quality score; and
modifying content outputted in a user interface of the online system based on the adjusted calculation of the relevance score.

2. The method of claim 1, further comprising:
inputting values of the features for additional opportunities and values of labels representing levels of user engagement with the additional opportunities as training data for the first machine learning model; and
updating parameters of the first machine learning model based on the values of the features and the values of the labels.

3. The method of claim 2, further comprising:
selecting the features as input to the first machine learning model based on effects of the features on outcomes indicating the levels of user engagement with the additional opportunities; and
determining, based on the outcomes, the values of the labels for the additional opportunities while controlling for external factors that affect the values of the labels.

4. The method of claim 3, wherein the external factors comprise at least one of:
a recency of the opportunity;
a type of posting of the opportunity in the online system; and
one or more of the attributes.

5. The method of claim 2, wherein the labels comprise at least one of:
an impression volume;
a click-through rate;
a rate of applications to an additional opportunity, given impressions of the additional opportunity; and
a rate of response to the applications.

6. The method of claim 1, further comprising:
matching the opportunity to an additional opportunity with identical values in a first subset of the attributes;
calculating a similarity of the opportunity to an additional opportunity based on comparisons of an embedded representation of the opportunity with an additional embedded representation of the additional opportunity; and
modifying the content outputted in the user interface of the online system based on the similarity.

7. The method of claim 6, wherein modifying the content outputted in the user interface of the online system based on the similarity comprises:
when the similarity exceeds a threshold, omitting output of a lower quality opportunity selected from the opportunity and the additional opportunity to the user.

8. The method of claim 6, wherein the first subset of the attributes comprises:
a title;
a region; and
a company.

9. The method of claim 1, further comprising:
outputting one or more factors that contribute to a low value of the quality score.

10. The method of claim 1, wherein adjusting the calculation of the relevance score based on the quality score comprises:
applying a second machine learning model to the quality score and additional features related to the opportunity and the user to produce the relevance score.

11. The method of claim 1, wherein adjusting the calculation of the relevance score based on the quality score comprises:
when the quality score falls below a threshold, omitting calculation of the relevance score between the opportunity and the user.

12. The method of claim 1, wherein determining the features related to the completeness of the attributes in the opportunity comprises:
generating indicators of the presence or absence of standardized attributes in the opportunity, wherein the standardized attributes comprise at least one of a title, a skill, a function, a seniority, an industry, a region, and a company.

13. The method of claim 1, wherein determining the features related to the completeness of the attributes in the opportunity comprises:
generating an indicator of the presence or absence of a company picture in the opportunity.

14. The method of claim 1, wherein determining the features related to the source of the opportunity comprises:
generating a feature that identifies the source of the opportunity as a moderator of the opportunity or a third-party source.

15. A system, comprising:
one or more processors; and
memory storing instructions that, when executed by the one or more processors, cause the system to:
determine, based on data retrieved from a data store in an online system, features related to:
a completeness of attributes in an opportunity posted in the online system; and
a source of the opportunity;
perform one or more operations that apply a first machine learning model to the features to generate a quality score representing a prediction of user engagement with the opportunity;
adjust calculation of a relevance score representing a likelihood of a positive outcome between a user and the opportunity based on the quality score; and
modifying content outputted in a user interface of the online system based on the adjusted calculation of the relevance score.

16. The system of claim 15, wherein the memory further stores instructions that, when executed by the one or more processors, cause the system to:
select the features as input to the first machine learning model based on effects of the features on outcomes indicating levels of user engagement with additional opportunities;
determine, based on the outcomes, values of labels for the additional opportunities while controlling for external factors that affect the values of the labels;
input the values of the features for additional opportunities and the values of the labels as training data for the first machine learning model; and
update parameters of the first machine learning model based on the values of the features and the values of the labels.

17. The system of claim 15, wherein the memory further stores instructions that, when executed by the one or more processors, cause the system to:
match the opportunity to an additional opportunity with identical values in a first subset of the attributes;
calculate a similarity of the opportunity to an additional opportunity based on comparisons of an embedded representation of the opportunity with an additional embedded representation of the additional opportunity; and
modify the content outputted in the user interface of the online system based on the similarity.

18. The system of claim 15, wherein adjusting the calculation of the relevance score based on the quality score comprises at least one of;
applying a second machine learning model to the quality score and additional features related to the opportunity and the user to produce the relevance score; and
when the quality score falls below a threshold, omitting calculation of the relevance score between the opportunity and the user.

19. The system of claim 15, wherein determining the features related to the completeness of the attributes in the opportunity comprises:
generating indicators of the presence or absence of a title, a skill, a function, a seniority, an industry, a region, a company, and a company picture in the opportunity; and
generating a feature that identifies the source of the opportunity as a moderator of the opportunity or a third-party source.

20. A non-transitory computer-readable storage medium storing instructions that when executed by a computer cause the computer to perform a method, the method comprising:
determining, based on data retrieved from a data store in an online system, features related to:
a completeness of attributes in an opportunity posted in the online system; and
a source of the opportunity;
performing one or more operations that apply a first machine learning model to the features to generate a quality score representing a prediction of user engagement with the opportunity;
adjusting calculation of a relevance score representing a compatibility between a user and the opportunity based on the quality score; and
modifying content outputted in a user interface of the online system based on the adjusted calculation of the relevance score.
